(19) United States
(12) Patent Application Publication
(10) Pub. No.: US 2022/0057142 A1
(43) Pub. Date: Feb. 24, 2022

(54) COMPACT AND SELECTIVE REACTION CHAMBER

(71) Applicant: THERMO ENVIRONMENTAL INSTRUMENTS LLC, Franklin, MA (US)

(72) Inventors: Robert Bailey, Bellingham, MA (US); Bryan Marcotte, Blackstone, MA (US); King Poon, Missouri City, TX (US); Jeffrey Socha, Boylston, MA (US); Mark Rossmeisl, Franklin, MA (US)

(21) Appl. No.: 17/445,234

(22) Filed: Aug. 17, 2021

Related U.S. Application Data
(60) Provisional application No. 62/706,477, filed on Aug. 19, 2020.

(51) Int. Cl. F28D 7/08; F28F 9/02

(52) U.S. Cl. CPC F28D 7/085; F28F 9/0243

(57) ABSTRACT

An embodiment of a reaction chamber is described that comprises a block of a material comprising a heat source positioned in a central location and a continuous channel comprising an inlet positioned at a first peripheral area of the block and an outlet positioned at a second peripheral area of the block, wherein the channel comprises a serpentine path from the inlet past the centrally located heat source to the outlet.

### FIELD OF THE INVENTION

The present invention is generally directed to a compact reaction chamber constructed with the least amount of material needed to maximize the residence time of a fluid that may include a gas or liquid, traveling through a continuous channel.

### BACKGROUND

It is generally appreciated that embodiments of heat exchanger systems configured to mix and/or react selective gasses have been described, however such systems are generally not constrained by space requirements and thus are large and bulky. The large size of the systems provides sufficient residence time for effective efficient transfer of heat as well as to achieve substantially complete reaction of the desired gasses.

However, in certain applications it is desirable to have a very compact design due to space constraints as well as cost considerations. For example, air monitor systems useful for continuous emission monitoring (e.g. from power plants, etc.) typically employ heat exchangers for selective reaction of gasses where it is desirable that the air monitor uses as little space as possible while being robust and cost effective. As such systems become more compact there has been a tradeoff that results in a reduced residence time of the gasses in the heat exchanger and consequent reduction in efficiency of heat transfer and reaction efficiency of the gasses.

Therefore, a need exists for a compact part to mix, preheat, and/or cool a fluid (e.g. a gas or liquid sample) and/or to react selective gases with as much residence time as possible.

### SUMMARY

Systems, methods, and products to address these and other needs are described herein with respect to illustrative, non-limiting, implementations. Various alternatives, modifications and equivalents are possible.

An embodiment of a reaction chamber is described that comprises a block of a material comprising a heat source positioned in a central location and a continuous channel comprising an inlet positioned at a first peripheral area of the block and an outlet positioned at a second peripheral area of the block, wherein the channel comprises a serpentine path from the inlet past the centrally located heat source to the outlet.

In some embodiments the block is substantially cylindrical and in some cases, may comprise a ratio of a volume of the material to a volume of the channel of about 2.8:1. The channel may also include about 21 square inches of surface area, and the heat source can be configured to heat the central location to a conversion temperature of a first gas that can include a temperature that decomposes a gas such as ozone. In some embodiments, the gas conversion temperature is in a range from 50° C. to 325° C. that may include a temperature that does not decompose a second gas such as SO₂.

Further, in some instances the block is substantially solid, and may be constructed of a metal material such as, for instance, a stainless-steel metal. Also, the block may have a dimension of about 1.5″ high by 1.6″ wide, where the channel may have a rough internal surface. In some cases, the rough internal surface comprises features of at least 10 μm in height.

An embodiment of an analyzer is described that comprises an air monitor that includes reaction chamber constructed of a block of a material comprising a heat source positioned in a central location and a continuous channel comprising an inlet positioned at a first peripheral area of the block and an outlet positioned at a second peripheral area of the block, wherein the channel comprises a serpentine path from the inlet past the centrally located heat source to the outlet.

In certain embodiments, the block comprises a ratio of a volume of the material to a volume of the channel of about 2.8:1. Further, the heat source can be configured to heat the central location to a conversion temperature of a first gas that may include a temperature in a range from 50° C. to 325° C. In the same or alternative embodiments, the material may comprise a metal and/or the channel may have a rough internal surface.

The above embodiments and implementations are not necessarily inclusive or exclusive of each other and may be combined in any manner that is non-conflicting and otherwise possible, whether they are presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiment and implementations are illustrative rather than limiting.

### BRIEF DESCRIPTION OF THE DRAWINGS

The above and further features will be more clearly appreciated from the following detailed description when taken in conjunction with the accompanying drawings. In the drawings, like reference numerals indicate like structures, elements, or method steps and the leftmost digit of a reference numeral indicates the number of the figure in which the references element first appears (for example, element 110 appears first in FIG. 1). All of these conventions, however, are intended to be typical or illustrative, rather than limiting.

FIG. 1 is a functional block diagram of one embodiment of an air monitor in communication with a computer;

FIG. 2 is a simplified graphical representation of one embodiment of a reaction chamber with a reaction channel;

FIG. 3A is a simplified graphical representation of a side view of one embodiment of the reaction channel of FIG. 2;

FIG. 3B is a simplified graphical representation of one embodiment of a top view of the reaction channel of FIG. 2;

FIG. 4 is a simplified graphical representation of one embodiment of a top view of the reaction chamber of FIG. 2;

FIGS. 5A-C are simplified graphical representations of cutaway views on a transverse plane of one embodiment of the reaction chamber of FIG. 2;

FIG. 6 is a simplified graphical representation of a cutaway view on a longitudinal plane of one embodiment of the reaction chamber of FIG. 2; and

FIG. 7 is a simplified graphical representation of a graph illustrating the ability of the reaction chamber of FIG. 2 to destroy ozone.

Like reference numerals refer to corresponding parts throughout the several views of the drawings.

### DETAILED DESCRIPTION OF EMBODIMENTS

As will be described in greater detail below, embodiments of the described invention include a compact reaction chamber constructed with the least amount of material needed to maximize the residence time of a gas traveling through a continuous channel. More specifically, the continuous channel of the compact reaction chamber is configured with a serpentine path and a rough interior surface that improves the efficiency of gas reaction in the channel.

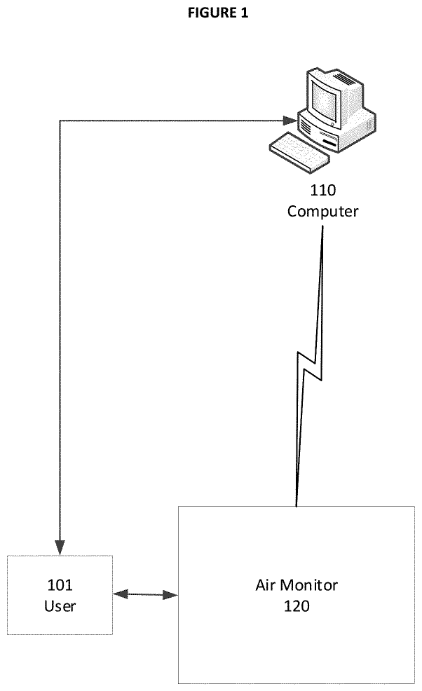

FIG. 1 provides a simplified illustrative example of user 101 capable of interacting with computer 110 and air monitor 120. Embodiments of air monitor 120 may include a variety of commercially available air monitors. For example, air monitor 120 may include the iQ series of gas analyzer instruments available from Thermo Fisher Scientific. FIG. 1 also illustrates a network connection between computer 110 and air monitor 120, however it will be appreciated that FIG. 1 is intended to be exemplary and additional or fewer network connections may be included. Further, the network connection between the elements may include “direct” wired or wireless data transmission (e.g. as represented by the lightning bolt) as well as “indirect” communication via other devices (e.g. switches, routers, controllers, computers, etc.) and therefore the example of FIG. 1 should not be considered as limiting.

Computer 110 may include any type of computing platform such as a workstation, a personal computer, a tablet, a “smart phone”, one or more servers, compute cluster (local or remote), or any other present or future computer or cluster of computers. Computers typically include known components such as one or more processors, an operating system, system memory, memory storage devices, input-output controllers, input-output devices, and display devices. It will also be appreciated that more than one implementation of computer 110 may be used to carry out various operations in different embodiments, and thus the representation of computer 110 in FIG. 1 should not be considered as limiting.

In some embodiments, computer 110 may employ a computer program product comprising a computer usable medium having control logic (e.g. computer software program, including program code) stored therein. The control logic, when executed by a processor, causes the processor to perform some or all of the functions described herein. In other embodiments, some functions are implemented primarily in hardware using, for example, a hardware state machine. Implementation of the hardware state machine so as to perform the functions described herein will be apparent to those skilled in the relevant arts. Also, in the same or other embodiments, computer 110 may employ an internet client that may include specialized software applications enabled to access remote information via a network. A network may include one or more of the many types of networks well known to those of ordinary skill in the art. For example, a network may include a local or wide area network that may employ what is commonly referred to as a TCP/IP protocol suite to communicate. A network may include a worldwide system of interconnected computer networks that is commonly referred to as the internet, or could also include various intranet architectures. Those of ordinary skill in the related art will also appreciate that some users in networked environments may prefer to employ what are generally referred to as “firewalls” (also sometimes referred to as Packet Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

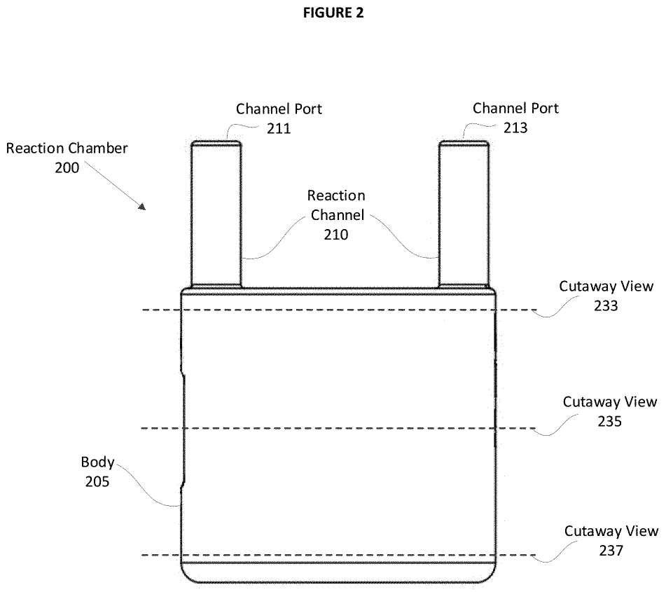

FIG. 2 provides an illustrative example of a side view of an embodiment of reaction chamber 200 that includes reaction channel 210 with channel ports 211 and 213 that fluidically couple channel 210 to components of air monitor 120. It may be desirable that reaction chamber 200 comprises a substantially cylindrical shape, however it will be appreciated that other shapes may be advantageous for certain applications. Also, channel port 211 may serve as an inlet port for a fluid to enter reaction channel 210 and channel port 213 may serve as an outlet port for a fluid to exit reaction channel 210. It will, however, be appreciated that channel port 213 may serve as the inlet port and channel port 211 may serve as the outlet port. In some embodiments, it may be desirable that reaction chamber 200 is self-supporting, and may in some embodiments be configured as a mechanical support for one or more components within air monitor 120.

Reaction chamber 200 includes body 205 that may be constructed from a metallic material, in some cases comprising an alloy with desirable components for one or more reactions such as, for example, molybdenum for reducing NO₂. In an alternative example, body 205 may be constructed from stainless steel (e.g. for ozone destruction) or non-stainless steel, copper, and/or aluminum. The inner surface of reaction channel 210 and/or outer surface of reaction chamber 200 may also be plated with one or more variable thermally conductive “sub metals” that provides a combination of surface materials desirable for various selective reactions. Further, some plating may have additional benefits such as, for example, gold plating that may provide corrosion resistance to protect reaction chamber 200 from corrosive gasses that may include ammonia gas.

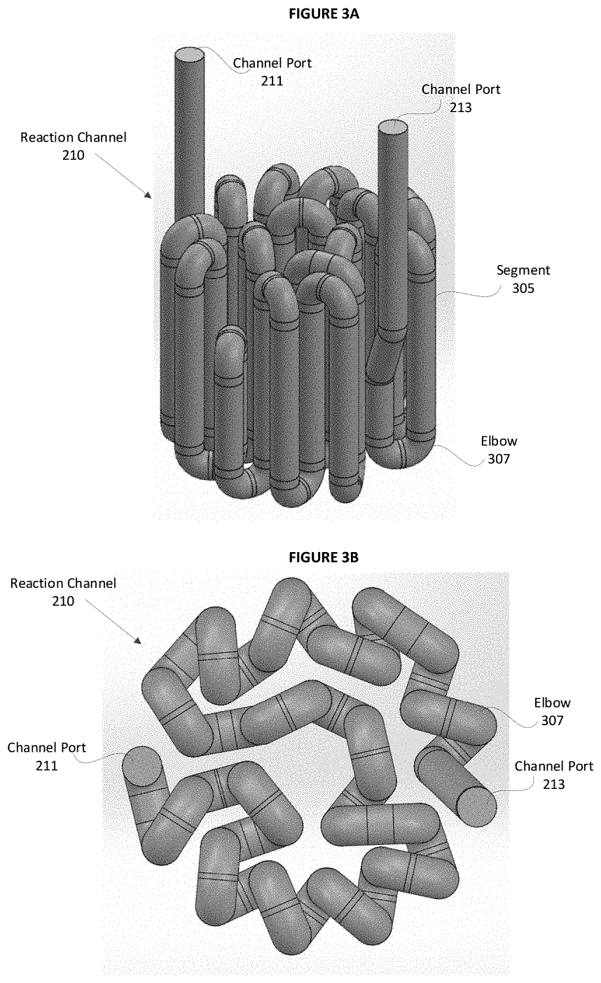

In the described embodiments, reaction channel 210 follows a serpentine and/or a helical path within body 205, an example of which is illustrated in FIGS. 3A and 3B. For example, reaction channel 210 may be configured with a plurality of segments 305 that may be substantially straight or have some degree bend, and a plurality of elbows 307 that substantially change the direction of flow within reaction channel 210. In the examples of FIGS. 3A and 3B the change of direction may be about 180° that produces a collision of the flowing fluid with the walls of reaction channel 210 (e.g. an abrupt change of direction) that promotes an increase in mixing and heat transfer. Overall the configuration of reaction channel 210 forms a compact arrangement for efficient mixing and/or heat transfer. Also in the present example, the interior surface of reaction channel 210 comprises a degree of roughness (e.g. comprises texture) that is configured to produce turbulent flow of fluids within reaction 210 that also promotes mixing as well as efficient heat transfer. The surface roughness may also serve to disrupt the formation of a boundary layer that typically forms with laminar flow. In some embodiments, it may be desirable that the internal surface of reaction channel 210 comprises features of at least 10 μm in height. For example, the degree of roughness of internal surface of reaction channel 210 may depend, at least in part, on the choice of manufacturing process and materials used. For instance, as described in further detail below when an additive manufacturing instrument is used to manufacture body 205 with reaction channel 210, the finish of the internal surface of reaction channel 210 may depend on the size of particles used with the additive manufacturing instrument that may include particles in a range of 2-80 microns. In some embodiments, a particle size of 30 microns produces desirable results.

The serpentine and/or helical configuration of reaction channel 210 maximizes the length of reaction channel 210 in body 205 which produces a long residence time for a fluid within reaction channel 210. For example, body 205 may be about 1.5″ in height and about 1.6″ in diameter with a path length of reaction channel 210 of about 44″ and a nominal internal diameter of channel 210 of about 0.15″ (e.g. reaction channel 210 may include an internal channel volume of about 12.7 CC). In an alternative example, body 205 may be about 1″ tall and about 1.1″ in diameter with a pathlength of about 18″ and a nominal internal diameter of channel 210 of about 0.12″. Those of ordinary skill in the art will appreciate that the dimensions of body 205 and/or reaction channel 210 may be configured to achieve the desired path length, nominal internal diameter, or other characteristics. Therefore, the presently described examples should not be considered as limiting.

The path of reaction channel 210 may be configured so that there is a minimum wall thickness between segments 305 of reaction channel 210 that are in close proximity to one another. For example, the nominal width (e.g. wall thickness) between segments 305 may be in a range of about 0.01″-0.04″. Importantly, it is desirable that body 205 is constructed with the least amount of material for the amount of volume and surface area provided by reaction channel 210, which may be limited by the method used to manufacture body 205 (e.g. the amount of material may be defined by the limits of the manufacturing technology used). It may be desirable that body 205 has a minimal ratio of the volume of material for body 205 to the volume of reaction channel 210 (e.g. a 1:1 ratio where the volume of the material is substantially the same as the volume of reaction channel 210). For example, reaction chamber 200 may be constructed using an additive manufacturing instrument (also sometimes referred to as three dimensional or 3D printing instrument) that may include what is sometimes referred to as an Electron Beam Additive Manufacturing instrument (EBAM instrument). In the presently described example, an embodiment of reaction chamber 200 may be constructed of stainless steel 316L (e.g. using CL 20 ES powder) printed with 30-micron thick layers where the ratio includes a volume of material in body 305 to volume of reaction channel 210 of about 2.8:1. In the described example, the surface area of reaction channel 210 may be about 21 square inches.

It will also be appreciated that reaction chamber 200 may be constructed by joining sections together. For example, pieces may be produced by casting, milling, or by other methods known in the art for producing pieces with the desired characteristics. The pieces may be joined by welding, using gaskets and screws, or other method of joining known in the art. Importantly, the methods used need to produce an embodiment of reaction chamber 200 that will not leak fluid, particularly at high temperatures where the embodiment of reaction chamber 200 may be employed (e.g. at temperatures up to 700° C.).

Those of ordinary skill in the art appreciate that while FIGS. 2, 3A, and 3B illustrate and discuss a single channel, reaction chamber 200 may include 2 or more channels. In fact, the number of channels may only be limited by the dimension of reaction chamber 200.

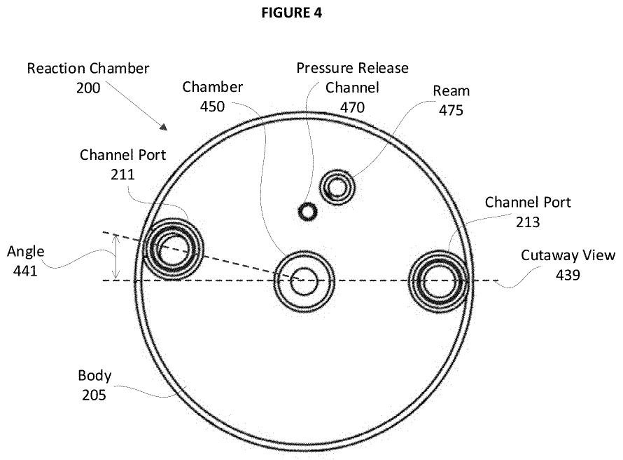

FIG. 4 provides an illustrative example of a top view of an embodiment of reaction chamber 200 that includes chamber 450 configured to house a source of heating and/or cooling for reaction chamber 200. It may be desirable that chamber 450 houses a source of heat in applications for the selective reaction of gasses, where the source of heat may include a thermoelectric component or other suitable source known in the art. For example, chamber 450 may include a resistive heater cartridge, or inductive heat source. In the same or alternative example, a by-polar thermoelectric (e.g. Peltier) element can be used to supply heat or draw heat out to cool reaction chamber 200. As a further example, what is sometimes referred to as a “band clamp” heating element could be employed where the band clamp is typically positioned around the external surface of body 205 where heat would transfer between the band clamp and body 205.

In the described embodiments, the path of reaction channel 210 within body 205 is configured so that there is efficient mixing and/or heat transfer as the fluid travels towards chamber 450 and away from chamber 450 (e.g. fluid may heat as it flows towards chamber 450 and cool as it flows away). In some embodiments, it may be desirable that the rate of heating and cooling within body 205 is substantially even, however in other embodiments an even rate may not provide a beneficial effect. FIG. 4 also illustrates pressure release channel 470 and ream 475. Pressure release channel 470 may, in some embodiments, operatively connect to ream 475 and function to relieve excessive pressure build up within ream 475 that may include a temperature probe positioned therein.

FIG. 4 also illustrates an embodiment of reaction chamber 200 where channel ports 211 and 213 are offset from each other relative to a plane through the center of reaction chamber 200 (e.g. illustrated by cutaway view 439 and angle 441). For example, angle 441 may include an angle of about 13.8°.

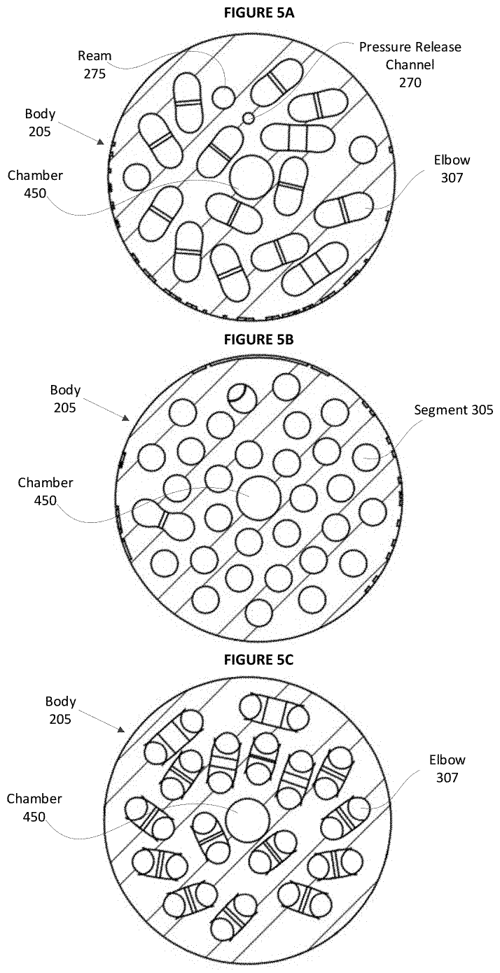

FIGS. 5A, 5B, and 5C provide illustrative examples of cross section views at a transverse plane through body 205 that show the arrangement of the structures at the relative depth in body 205. Again, FIGS. 5A-C illustrate that reaction chamber 200 comprises a minimal ratio of the volume of material for body 205 to the volume of reaction channel 210. For example, FIG. 5A illustrates the cross-section view of the structure at the depth of cutaway view 233 that is near the top of body 205 where reaction channel 210 mostly includes elbows 307; FIG. 5B illustrates the cross-section view of the structure at the depth of cutaway view 235 that is near the middle of body 205 where reaction channel 210 mostly includes segments 305; and FIG. 5C illustrates the cross-section view of the structure at the depth of cutaway view 237 that is near the bottom of body 205 where reaction channel 210, again, mostly includes elbows 307.

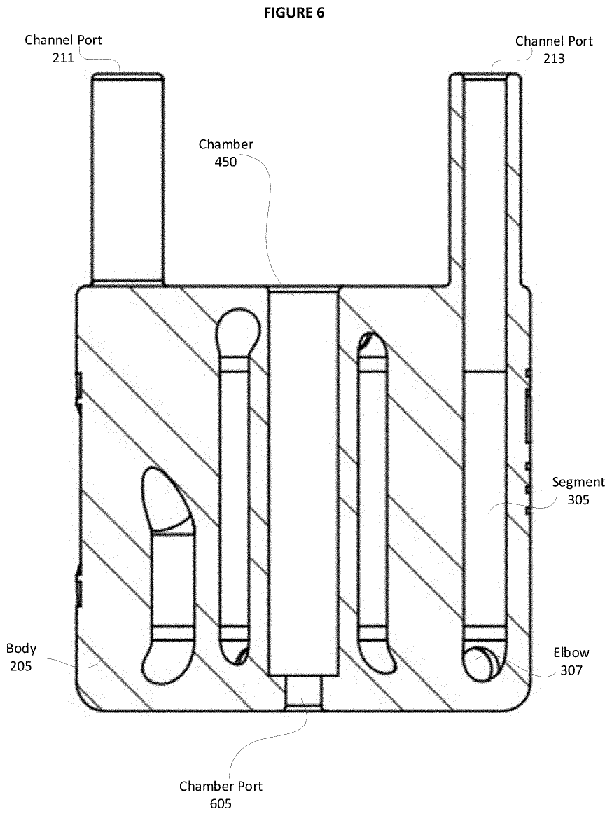

Similarly, FIG. 6 provides an illustrative example of a cross section view through body 205 that show the arrangement of the structures at a longitudinal plane through the center of body 205. For example, FIG. 6 illustrates the cross-section view of the structure at the depth of cutaway view 439 that includes chamber 450 with chamber port 605 that may function for pressure relief and/or to drain fluid from chamber 450.

As described above, reaction chamber 200 is useful for applications that include, but are not limited to mixing fluids without reaction, or for selective reaction of fluids at high temperatures as well as at ambient temperatures. For example, the selective reaction and reduction of ozone without significantly causing a reaction of SO₂. In the present example, the level of a selected gas can be measured by other components in air monitor 120. In the presently described example, reaction chamber 200 can substantially remove ozone (e.g. decompose the ozone component of a fluid gas) from a sample gas mixture by operating at a temperature above about 170° C.

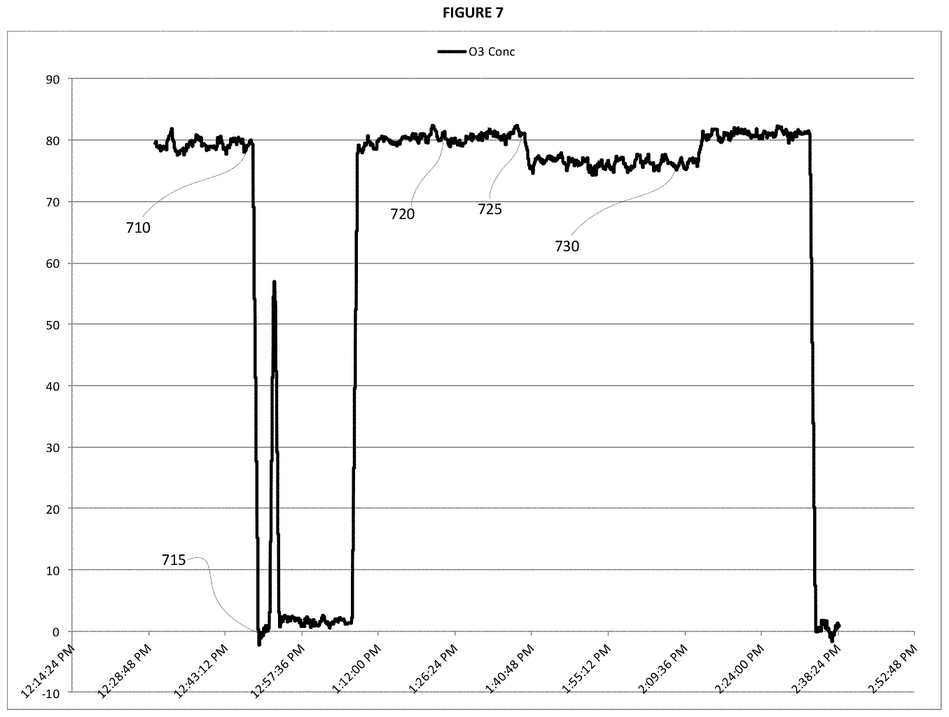

FIG. 7 provides an example of results obtained from an embodiment of reaction chamber 200 set to operate at 180° C. and that utilized 80ppb ozone gas (e.g. O₃). In the described example, air monitor 120 included two separate alternating channels of gas flow, a first that went through reaction chamber 200 (e.g. as a reference gas flow) where the ozone was destroyed. The other bypassed reaction chamber 200 (e.g. as a sample gas flow) where the ambient ozone stayed intact. The difference in the ozone concentration between the reference flow and sample flow was recorded as the ozone concentration.

At point 710, air monitor 120 was calibrated with the 80 ppb O₃ gas, and zeroed out at point 715 (e.g. introduced “zero air” that is a gas free of analytes of interest). The zero air is used to set the background. During range 720, the O₃ baseline was measured at 80.9 ppb. At point 725 10.46 ppm SO₂@0.225 lpm was introduced into 3.853 lpm of 80 ppb O₃ creating 611 ppb SO₂. At point 730, the expected diluted O₃ measurement was 76.4 ppb with an actual measurement of 76.3 ppb indicating only 0.1 ppb interference was produced from SO₂. This shows that reaction chamber 200 successfully allowed the SO₂ through reaction chamber 200 unharmed while destroying the O₃. Thus, the reference gas and the sample gas both had equal amounts of SO₂ and therefore any potential interference of SO₂ was canceled out. In other words. Reaction chamber 200 efficiently scrubbed O₃ from the sample gas while allowing SO₂ to pass through.

Having described various embodiments and implementations, it should be apparent to those skilled in the relevant art that the foregoing is illustrative only and not limiting, having been presented by way of example only. Many other schemes for distributing functions among the various functional elements of the illustrated embodiments are possible. The functions of any element may be carried out in various ways in alternative embodiments

What is claimed is:

1. A reaction chamber comprising:
a block of a material comprising a heat source positioned in a central location and a continuous channel comprising an inlet positioned at a first peripheral area of the block and an outlet positioned at a second peripheral area of the block, wherein the channel comprises a serpentine path from the inlet past the centrally located heat source to the outlet.

2. The reaction chamber of claim 1, wherein:
the block is substantially cylindrical.

3. The reaction chamber of claim 1, wherein:
the block comprises a ratio of a volume of the material to a volume of the channel of about 2.8:1.

4. The reaction chamber of claim 1, wherein:
the channel comprises about 21 square inches of surface area.

5. The reaction chamber of claim 1, wherein:
the heat source is configured to heat the central location to a conversion temperature of a first gas.

6. The reaction chamber of claim 5, wherein:
the gas conversion temperature decomposes ozone.

7. The reaction chamber of claim 5, wherein:
the gas conversion temperature comprises a temperature above about 170° C.

8. The reaction chamber of claim 5, wherein:
the gas conversion temperature does not decompose SO₂.

9. The reaction chamber of claim 1, wherein:
the block is substantially solid.

10. The reaction chamber of claim 1, wherein:
the material comprises a metal.

11. The reaction chamber of claim 9, wherein:
the metal comprises stainless steel.

12. The reaction chamber of claim 1, wherein:
the block comprises a dimension of about 1.5″ high by 1.6″ wide.

13. The reaction chamber of claim 1, wherein:
the channel comprises a rough internal surface.

14. The reaction chamber of claim 13, wherein:
the rough internal surface comprises features of at least 10 μm in height.

15. An analyzer, comprising:
an air monitor that includes reaction chamber constructed of a block of a material comprising a heat source positioned in a central location and a continuous channel comprising an inlet positioned at a first peripheral area of the block and an outlet positioned at a second peripheral area of the block, wherein the channel comprises a serpentine path from the inlet past the centrally located heat source to the outlet.

16. The analyzer of claim 15, wherein:
the block comprises a ratio of a volume of the material to a volume of the channel of about 2.8:1.

17. The analyzer of claim 15, wherein:
the heat source is configured to heat the central location to a conversion temperature of a first gas.

18. The analyzer of claim 17, wherein:
the gas conversion temperature comprises a temperature above about 170° C.

19. The analyzer of claim 15, wherein:
the material comprises a metal.

20. The analyzer of claim 15, wherein:
the channel comprises a rough internal surface.
